(19) United States
(12) Patent Application Publication
(10) Pub. No.: US 2021/0078527 A1
(43) Pub. Date: Mar. 18, 2021

(54) Emergency Escape Quick Release Seat Belt

(71) Applicant: Neva Y. Holloway, Marcus Hook, PA (US)

(72) Inventor: Neva Y. Holloway, Marcus Hook, PA (US)

(21) Appl. No.: 17/006,824

(22) Filed: Aug. 29, 2020

Related U.S. Application Data
(60) Provisional application No. 62/922,807, filed on Aug. 30, 2019.

(51) Int. Cl. B60R 22/32

(52) U.S. Cl. CPC B60R 22/32

(57) ABSTRACT

A method of escape from locked seat belts in motorized vehicles. Quick release buckle is attached to the middle of the seat belt on the shoulder seat belt across the torso and the lap seat belt. It is a Manual buckle device. When activated by the passenger by pressing the button serves to separate locked engagement. The passenger can then escape from the automatic locked seat belts through the middle of the middle when the automatic seat belt malfunctions. This unit would be a permanent manual buckle release device attached to the seat belt harness by the seat belt factory. A quick release seat belt unit that attaches as an after to a pre-existing factory installed seatbelt. This Adaptation increases efficiency and safety to passengers in a wreck that would otherwise be trapped in their vehicles.

### BACKGROUND OF THE INVENTION

### Field of Invention

The present invention relates to seat belts in motorized vehicles with additional features for emergency escape. Passengers will have the to ability escape in emergencies and prevent entrapment in an accident.

### Description of Prior Art

Background of Invention Seat belts and other motorized vehicular seat restraint systems commonly feature a mechanical design wherein a user is restrained in a seated position by a combination of the Chrysler Uni belt better known as the 3-point seat belt shoulder strap component and a Lap strap component. The current safety restraint system design needs to be modified for the Passenger's safety. It has a faulty design. When an accident happens, and pressure is applied to the 3-point seat belt. The faulty design jeopardizes the passenger's safety, in the event of an accident the present seatbelt design does not function if any pressure or strain is applied to the seatbelt after a collision. When an accident occurs, if the automobile or vehicle lands on the side or ends up upside down. The current 3-point standard seat does not work. It locks in place due to stress placed on the seat belt upon impact the seat belts automatically lock. The seat belt remains fixed in the locked position. This makes it impossible for passengers to escape. Until the pressure placed on the seat belt must be subsided for the automated lock to disengage and release the passengers. This means the passengers are trapped and need some other device to free themselves a seat belt cutter, example: In the event if a vehicle is leaking gasoline or another type of flammable fluid, or if the vehicle is sinking into water the passenger will not be able to free themselves from the vehicle. This modification would make a passenger that was previously locked in a fixed position in the car seat and seat belt. With this enhancement modification the passenger would now be able to move through the middle of a locked seat belt into safety. In the event if a car ends up in a ditch, or lake upside down they are locked in the vehicle with the possible injury or loss of life. To avoid injuries caused by faulty seat belts in car wrecks. Many people have lost their lives being unable to escape a locked seat belt after surviving a motor vehicle crash.

### BRIEF SUMMARY OF THE INVENTION

The primary objective of this invention to provide is improvement to the 3-point seat belt system. In the event of entrapment passengers would be able escape a locked seat belt through the middle of the seat belt with this invention. The vehicle would keep the current Standard 3-point seat belt but with additional enhancements, safety features would be added to the webbing. The additional buckles would be a permanent manual buckle sewn into the seat belt on the shoulder and lap seat belt installed by the manufacturer. Each buckle should be able to withstand 2,000 pounds of pressure upon impact or the manufacturer speciation's. The passengers would be able to use the Emergency Escape Quick Release Seat Belt to release themselves in an accident. The additional buckle unit located on the webbing at the two major key points would provide a necessary key feature for passenger safety for a quick and easy release. The new enhanced system would consist of three seat belt buckles on the standard seat belt, instead of the current standard one lock. The two additional seat belt buckles would release the passengers as soon as the passenger pressed the manual buckles for a quick and easy release thus putting the passenger in control of their safety. The enhancements are designed for a quick release; they are not adjustable. This unit is not attached to the vehicle's electrical system. It is manual. The quick release unit would be activated by the passenger. This unit would be a permanent manual buckle release device attached to the seat belt harness by the seat belt factory. The quick release seat belt buckle that would be attached by the seat belt manufacturer. It can be installed quickly and inexpensively to the pre-existing factory seatbelt. The quick release seat belt buckle expedites exit from a factory-installed 3-point seatbelt, in an emergency. The current 3-point standard seat belt design's purpose is: It keeps vehicle occupants inside; It restrains the strongest parts of the body; Seat belts spread out the force of a collision; Helps the body to slow down; It protects your brain and spinal cord; Wearing a seat belt is required by law. The additional enhancement would reinforce the protection of the wearer by providing an emergency escape quick release through the middle of a locked seat belt if the automatic seat belt malfunctions.

### DRAWINGS

### Description of Drawings

A. Standard 3-point Seat Belt System anchored to the vehicle above the shoulder

B. Standard 3-point Seat Belt System anchored to the vehicle on the bottom of the seat for the female clasp to fit into the male automatic locking system.

C. Standard 3-point Seat Belt System anchored to vehicle at seat level to secure the lap seat belt webbing.

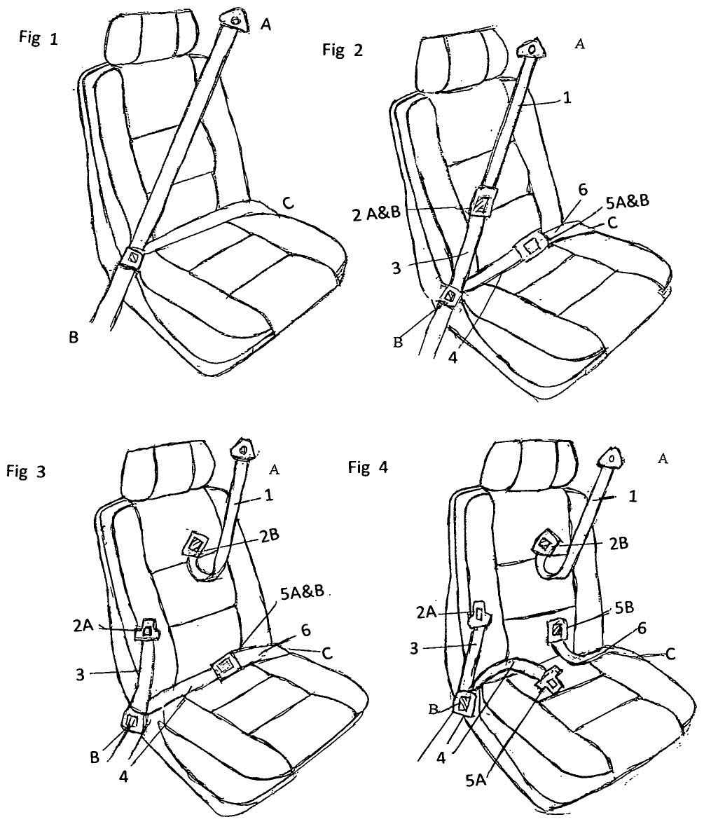

FIG. 1 Standard 3 Point Seat Belt in a locked position. As described above a 3 point seat belt restraint having one individual webs are permanently anchored at two points and connectable at one to a common buckle or hub at the other end.

[symbol]

FIG. 2: Enhanced Seat Belts both are Parts Closed A & B Emergency Escape Quick Release attached to the current standard 3-point seat belt system. One buckle is added to the shoulder webbing midpoint between points A and B one enhancement is added to the Lap webbing. 1. First webbing on the shoulder seat belt top section. 2. For Emergency Escape Quick release and locking clap on the shoulder webbing Points A & B. 3. Second webbing on the seat belt bottom section is closed. 4. First section webbing for lap seat belt Right. 5. Across the lap the Emergency Escape Quick Release Seat Belt Parts A & B Male & Female interlocking system are closed. This is what the enhanced system would look like with daily passenger use when the system is not engaged. 6. Second section webbing for lap seat belt Left.

FIG. 3: Enhanced Seat Belts Parts A is Opened; the passenger remains unable to escape through the middle of the seat belt, since Part B is Closed of the Emergency Escape Quick Release. Enhanced Seat Belts Part A is open and Part B is closed Emergency Escape Quick Release attached to the current standard 3-point seat belt system. One buckle is added to the shoulder webbing midpoint between point and one enhancement is added to the Lap webbing midpoint between. 1. First webbing on the shoulder seat belt top section is opened. 2. For Emergency Escape Quick release and locking clasp on the shoulder webbing Parts. 3. Second webbing on the seat belt bottom section is opened. 4. First section webbing for lap seat belt Right. 5. Across the lap the Emergency Escape Quick Release Seat Belt Parts A & B Male & Female interlocking system remains locked, or Side Squeeze. to be determined by manufacturer for safety standards. 6. Second section webbing for lap seat belt Left remains locked

FIG. 4: Enhanced Seat Belts Parts A & B are both opened. Emergency escape Quick Release Now it is possible for the passenger to escape through the middle of a locked Seat belt. The enhancement buckles are not adjustable.

Enhanced Seat Belts both are Parts opened A & B Emergency Escape Quick Release attached to the current standard 3-point seat belt system. One buckle is added to the shoulder webbing midpoint between Points A and B one enhancement is added to the Lap webbing midpoint between points B and C. 1. First webbing on the shoulder seat belt top section is opened. 2. For Emergency Escape Quick release and locking clasp on the shoulder webbing between points A and B are opened. 3. Second webbing on the seat belt bottom section is opened with the release of section between points B and C. 4. First section webbing for the lap seat belt Right is opened. But parts 3 & 4 remain locked and attached to the vehicle while the passenger escapes through the middle of the locked seat belt. 5. Across the lap the Emergency Escape Quick Release Seat Belt Parts A & B Male & Female interlocking system is opened, or Side Squeeze. to be determined by manufacturer for safety standards. 6. Second section webbing for the lap seat belt Left is opened. While section 1 and section 6 remain attached to the vehicle while the passengers through the middle for a quick escape.

### DETAILED DESCRIPTIONS

The primary objective of this invention is to provide improvement to the 3-point seat belt system. The additional buckles would be a permanent manual buckle sewn into the seat belt on the shoulder and lap seat belt installed by the manufacturer. Each buckle should be able to withstand 2,000 pounds of pressure upon impact or the manufacturer speciation's. The passengers would be able to release in an accident the seatbelt. This action would allow the passenger to escape through the middle of a locked seat belt. This buckle would not be attached to the vehicle's electrical system. The emergency quick release seat belt buckle would be activated by the passenger. The passenger engaged would apply pressure to the buckles to open and release the seat belt. FIG. 3 Part A.

The passenger would release the 1st shoulder strap buckle attached to the seatbelt. FIG. 4 Part B. The passenger would release the 2^{nd} lap buckle attached to the lap seat belt. The first and second shoulder straps illustrated in FIG. 4 shows Part A & Part B, both seatbelts open manually for a quick escape. The passenger would escape through the middle of the still intact locked seatbelt. The vehicle would keep the and employ the current Standard 3-point seat belt but with added enhanced safety modifications of the seatbelt for an easy escape through the middle of a locked belt. The manufacturer would only need to add the additional buckle to the middle of the shoulder and lap points on the seatbelt. This would provide the necessary key enhancements for the passenger safety for a quick and easy release. This action would free the passenger making it possible for them to exit the seat belt through the middle of a locked belt and exit the vehicle. The passenger would no longer be completely dependent on the current inefficient 3-point seat belt system that is designed to lock when pressure is applied to the seat belt. The new enhanced system would consist of three buckles on the standard seat belt instead or the standard one lock. The added two additional seat belt buckles would release the passengers as soon as the passenger pressed the units for a quick and easy release thus putting the passenger in control of their safety. Yet another advantage of the present invention is that it is easy and inexpensive to install. Still another advantage of the present invention is that it is structured to fit over a wide variety of types of seat belt buckles.

This Enhancement of the additional opening and reclosing of the buckle unit on the seatbelt. This could be made from metal or a hard-durable plastic that could withstand the weight impact of a car accident, but not limited to metal hinges etc. . . . The passengers would be able to remove themselves from the frozen locked seatbelt without having to search for additional devices, exp: seat belt cutters. This invention from two preexisting items will make the current seat belt safer and more efficient. It will also save lives and help to reduce injuries.

### Cited References

U.S. Pat. No. 6,368,227 Issued November 2000 to Olsen Swing This patent concerns the movement method of a swing. It was issued for a movement. A method of swing swing is disclosed, in which a user positioned on a standard swing suspended by two chains from a substantially horizontal tree branch induces side to side motion by pulling alternately on one chain and then the other.

U.S. Pat. No. 3,484,908, issued Dec. 23, 1969 to Lamb, discloses a cover member for use with a safety belt of the type that has a quick release lever, which when lifted outwardly from the body Serves to Separate the male insert from the locked engagement in the female receptacle. The cover member is designed to Slidably engage and Surround the female receptacle So when it is in position, it is Impossible to accidentally operate the quick release lever.

U.S. Pat. No. 4,674,303, issued Jun. 23, 1987 to Salcone, II, discloses a Safety lock for a Seat belt buckle that includes a housing for receiving and containing the Seatbelt buckle therein and a locking portion for releasably retaining the housing in a closed position wherein the buckle is Substantially enclosed therein. When the safety lock is assembled in the closed position on a Seat belt buckle and the buckle is utilized for detachably interconnecting first and Second Seat belt Sections, the Safety lock restricts access to the buckle in a manner which normally prevents a Small child from disconnecting the Seat belt Sections but nevertheless permits the Seatbelt Sections to be easily disconnected by an adult. multi-step operation or the force required for actuating it.

U.S. Pat. No. 5,442,840, issued Aug. 22, 1995 to Ewald, concerns a Seatbelt buckle Safety sheath, which prevents the inadvertent releasing of the Seat belt buckle by young children. Specifically, the seat belt buckle safety sheath is made of a resilient material and frictionally encompasses the female portion of the seat belt buckle.

The resilient material of the Safety sheath imposes a compressive force Substantially greater than the normal force required to release the seat belt buckle from a fastened condition. Thus, an adult can compress the resilient material to activate the Seat Belt buckle release button, while a child will be prevented from accomplishing Same.

U.S. Pat. No 4,677,303 Issued June 1987 Safety lock for seat belt buckle A safety lock for a seat belt buckle includes a housing for receiving and containing the seat belt buckle therein and a locking portion for releasably retaining the housing in a dosed position wherein the buckle is substantially enclosed therein. When the safety lock is assembled in the closed position on a seat belt buckle and the buckle is utilized for detachably interconnecting first and second seat belt sections, the safety lock restricts access to the buckle in a manner which normally prevents a small child from disconnecting the seat belt sections but nevertheless permits the seat belt sections to be easily disconnected by an adult.

U.S. Pat No. 20080054615 Issued March 2008 Inventor: Sherri L. Coultrup, Alexandria, Va. A tactical quick release seat belt mechanism that attaches as an after-market enhancement to a pre-existing factory installed seatbelt. The tactical quick release seat belt mechanism expedites exit from a factory-installed 3-point seatbelt, particularly in an emergency. The tactical quick release allows tactical users such as law enforcement, military personnel, drug enforcement personnel, Homeland Security personnel, etc. to exit a vehicle quickly, without delay or snag of tactical equipment (e.g., weapons, communications backpack, etc.) on the 3-point seatbelt, and without the need to take their eye of a given target by looking down for the seat belt release button. The quick release mechanism inherently provides some extension to the length of the factory installed seatbelt, providing that much more flexibility and maneuverability for the occupant-particularly an occupant that is forward-leaning in the seat because of their wearing a backpack or similar tactical equipment while seated in the vehicle.

U.S. Pat. No 6,769,157 Issued August 2004 Inventor Patricia Meal St Cloud Fla. Safety guard for seat belt buckle release A seat belt buckle guard device is provided for preventing access to a release button on a seat belt. The device comprises a sleeve structured to fit over a variety of shapes and sizes of seat belt buckles. The sleeve comprises a front face and a top face that are capable of covering the front portion of a variety of seat belt buckles. The sleeve is made of sufficiently rigid material to prevent indentation of the faces and thereby prevent contact with both front and top belt buckle release button. The sleeve further comprises a split back face, which enables the sleeve to expand to fit over the variety of seat belt buckles. A top arm extending from the sleeve engages the seat belt strap with a tight friction fit to resist removal of the sleeve.

The manual release seat belt buckle will be attached to the 3-point seatbelt that crosses the torso body across the shoulder and across the lap anchored to the vehicle. The added manual seat belt enhancements added to the manufacture's seat belt webbing will make it possible for passengers to escape through the middle of locked seat belts during emergencies.

1. The seat belt buckle for the use in vehicles as claimed: 1. The passenger escapes quickly through the middle of the locked seatbelt buckle seat belt.

2. The seat belt buckle for the use in vehicles as claimed: 2 The passenger manually releases the locked seat belt, at two points, the shoulder seat belt webbing and the lap seat belt webbing to escape the vehicle.

3. The seat belt buckle for the use in vehicles as claimed: 3 The manual released seat belt buckles are attached to the middle section of the seatbelt, on the shoulder seat belt and on the lap seat belt. It would be installed by the seat belt manufacturer.

4. The seat belt buckle for the use in vehicles as claimed: 4 The manual release seat belt buckle is independent of the vehicle's automatic locked seat belt system. It can be opened and closed independently from the automatic electric seat belt system. This makes it possible for the passengers escapes through the middle of the locked seat belts

5. The seat belt buckle for the use in vehicles as claimed: 5 The passenger is in control and must activate the Emergency escape quick release seat belt at any angle, even with pressure being placed on the seat belt, during an accident.
